(19) United States
(12) Patent Application Publication
(10) Pub. No.: US 2013/0110838 A1
(43) Pub. Date: May 2, 2013

(54) METHOD AND SYSTEM TO ORGANIZE AND VISUALIZE MEDIA

(71) Applicants: Thomas Lidy, Wien (AT); Wolfgang Jochum, Vienna (AT); Ewald Peiszer, Vienna (AT)

(72) Inventors: Thomas Lidy, Wien (AT); Wolfgang Jochum, Vienna (AT); Ewald Peiszer, Vienna (AT)

(73) Assignee: SPECTRALMIND GMBH, Vienna (AT)

(21) Appl. No.: 13/808,484

(22) PCT Filed: Jul. 15, 2011
(86) PCT No.: PCT/EP11/62134

§ 371 Date: Jan. 4, 2013

Related U.S. Application Data
(60) Provisional application No. 61/366,210, filed on Jul. 21, 2010.

(51) Int. Cl. G06F 17/30

(52) U.S. Cl. CPC G06F 17/30598
USPC 707/737

(57) ABSTRACT

The invention concerns a method to organize and visualize electronic files (1) comprising media items (2) on an electronic device (3), characterised in that the method comprises the steps of accessing and opening the electronic files (1) and analysis of the media items (2) to extract content (4) and/or meta information (5); organization of media items (2) according to their similarity in content (4) and/or meta information (5); visualization of media items (2) as visual entities (6) laid out and/or placed on a user interface (7) according to their similarity. The invention further concerns a computer program implementing such a method and a computer readable medium comprising such a computer program, as well as an electronic device for organizing and visualizing electronic files comprising media items.

The present invention relates generally to a method and a system to organize and visualize electronic files comprising media items on an electronic device, the system comprising a user interface, a processing unit, and a storage unit.

### BACKGROUND

Digital music databases are gaining popularity both in terms of professional repositories as well as personal audio collections. Ongoing advances in network bandwidth and popularity of internet services anticipate even further growth of the number of people involved and working with audio libraries. However, organization of large music repositories is a tedious and time-intensive task, especially when the traditional solution of manually annotating semantic data to the media item is chosen.

Generally speaking, such databases analyze, organize and visualize a large pool of media items, represented as image files, audio files, video files, or other electronically stored items, Media pools can easily extend 100.000 distinct media items. For a user it is therefore of paramount importance to be able to browse, search, and filter such large databases based on specific criteria such as title, genre, album, and so forth. In addition to that, content-based features are increasingly useful for tasks like browsing by similarity, organization or classification of music.

Contentbased descriptors form the base for these tasks and are able to add semantic meta-data to music. However, there is no absolute definition of what defines the content, or semantics, of a media item.

Musical genre is probably the most popular metadata for the description of music content. Music industry promotes the use of genres and home users like to organize their audio collections by this annotation. Consequently, the need of automatic classification of audio data into genres arises.

Methods for the search and classification of electronic files comprising media items such as audio tracks are well known in the state of the art, for example in US 2002/0002899 A1. The classification of the content can be done by a plurality of feature vectors. Similarities are then defined by the distance between these vectors in a multidimensional vector space. However, commonly used feature vectors usually describe subjective characteristics of the media item, such as emotional quality, vocal quality, or genre. Such feature vectors cannot be extracted automatically, but must be tediously derived from the user, for example by using a questionnaire.

In addition to that, the organization and visualization based on these similarities only allows a one-dimensional representation, for example by a simple list of matching items. For a coarse search, hundreds or thousands of media items might match the search criteria within a specified similarity, and have to be looked through by the user.

It is therefore a purpose of the invention to overcome the limitations of the state of the art and realize a system for media item organization and visualization that allows for a fast exploration of vast collections of media items and to aggregate the available and extracted data in a proper way to avoid information overload and provide proper orientation while exploring the media pool content.

### SUMMARY OF THE INVENTION

To attain these purposes and others, a method to organize and visualize electronic files comprising media items on an electronic device is presented, which comprises the following steps:
accessing and opening the electronic files and analysis of the media items to extract content and/or meta information;
organization of media items according to their similarity in content and/or meta information;
visualization of media items as visual entities laid out and/or placed on a user interface according to their similarity.

By the organization of media items according to their similarity, navigation, search, and exploration of large media pools is extremely simplified for the user. Similar media items can be organized into groups, particularly hierarchical groups, for faster access. The content can comprise an audio signal, an audio waveform, a video signal, video content, text content, image content, or combinations thereof. It can be any electronically accessible content, particularly audio tracks, video clips, digital pictures or ebooks.

The meta information can comprise file-specific information such as file size, attached information such as ID3 tags, artist, or album, external information such as buying statistics, manually attached information such as tags, artist, album, or genre, automatically attached information such as usage statistics. Spectral features such as the rhythmic, timbral or visual structure can be extracted from the content of the media items on one or more frequency bands to assess the similarity of media items.

To visualize the media items and/or the groups, they can be placed on a grid, such as a two-dimensional grid or a three-dimensional grid. Since the media items according to the invention are characterized by a plurality of features based on content and/or meta information, the dimension of the feature vector has to be reduced for proper visualization. This can be performed by an iterative procedure known as self-organizing map training, by multidimensional scaling or by any other dimensionality reduction method. The creation of self-organizing maps and maps based on multidimensional scaling of multidimensional feature vectors is well known in the state of the art and is not described in detail.

Particularly, the positions of the media items on the grid can be stored in a Geographic Information System (GIS) utilizing a spezial database format for spatial data. This enables clients to quickly perform spatial queries such as zooming in and out. Particularly, the positions can be stored in a PostGIS database. This placement on the grid creates a map of media items, where similar media items are placed close together, and media items which differ strongly are placed far apart.

The visualization can comprise the steps of processing the grid data with a kernel of arbitrary, preferably radial, shape decreasing in size and peak detection to generate and place the visual entities. The visualization can also comprise a step of conversion of a two-dimensional grid of media items to a grayscale image. Image processing methods such as kernel correlation or smoothing can be used which are well known in the state of the art and are therefore not described in detail. Particularly, a count of media items per grid node can be performed, resulting in a matrix of frequencies per grid node. The matrix can then be convoluted with a radial kernel along the x-axis and the y-axis (for a two-dimensional grid) with decreasing radius. The chosen maximum kernel radius can be determined by the zoom level. Then, peaks can be detected, which indicate the location of cluster centers.

The visualizations of predetermined zoom levels can be precomputed and stored in a database for faster user access. The visual entities can comprise circles, circular structures, rectangular structures, polygons, colored shapes, three-dimensional objects, or combinations thereof.

The meta information can preferably be visualized using descriptive labels. Since there is often a plurality of labels describing different media items, there is a need to reduce the complexity of labels as well. Particularly, a plurality of labels can be clustered and the clusters can be labeled as such. The placement of the label clusters can be determined by the steps of estimation of the number of clusters for each possible label; k-means clustering for each possible label; determination of label position by its cluster center.

Alternatively, a plurality of labels can be clustered and the number and placement of the label clusters can be determined by the steps of hierarchical agglomerative clustering for each possible metadata label; cutting the hierarchical tree at specific positions; determinating the label positions by location of centroids of remaining clusters.

Again, the techniques of k-means clustering or hierarchical agglomerative clustering of data are well known in the state of the art and a detailed description is omitted.

The visualization can be adapted and/or changed through user input or automatically. Particularly, media items can be selected, retrieved, visualized, and/or played back, and/or moved into a shopping basket by user interaction. A media item player can be integrated into the visualization, incorporating functionalities such as: play back, pause, next track, last track, volume control, display information about the track (such as artist, album, title, genre, etc.), and display of a time bar. Extended functionalities include an equalizer, shuffle, repeat, and advanced visualization features (spectrum, etc.). Artist information, other meta information or related media items including music videos can be displayed. Search and filter functionalities can be provided, comprising a search field, where users can input their search criterion. The resulting media items can be highlighted in the visualization window. Additional information can be displayed, comprise information about the artist, song lyrics, links to videos, concerts, the cover, or comments of other users. These information might be provided by external databases, particularly from servers on the Internet.

The invention further comprises a computer program implementing a method according to the invention, and a computer readable medium comprising such a computer program.

Particularly, the steps in the method according to the invention can comprise:
1. Analysis of media items, in one or more of the following ways:
   a) processing meta information, such as but not limited to filename, title, author, artist, category, genre, publisher, etc.—derived from information provided with the media items either attached to them (e.g. through file system information), stored with the data (e.g. inside MPEG Layer 3 files in the ID3 tags) or provided from external sources (device databases, databases provided from different sources)
   b) processing meta information attached to media items by users explicitly (e.g. categories, tags, preferences, and other relevant information) or implicitly (usage statistics, buying statistics, analysis of user/user and user/item relations or other relevant information)
   c) processing content (e.g. audio signal, audio waveform, video signal, video content, image content, etc.) in a way to extract and derive characteristic information about the content
2. Clustering of data: Use of content and/or meta information as outlined in 1) to conduct a grouping or clustering of the data and provide aggregated information about grouping/clustering of content. Grouping/clustering is performed on various levels of detail, creating layers of coarser or finer grouping of data into more or less similar entitites. To achieve these similarities between items are computed based on different criteria. Multiple layers are created, which results in a hierarchical organization of the items, which is the key to this process and all further steps. Multiple layers in the hierarchy allow revealing more details or higher aggregation about media item groups/clusters through in- or decreasing level of detail.
3. Visual representation of data: The clustering/grouping of data by similar content and/or meta information as defined in 1) and 2) is used to create a graphical visualization, in one of several forms. Groups/clusters of media items and/or individual media items are shown by visual entitites, such as (for example, but not limited to) circles, circular structures, rectangular structures, colored shapes, three-dimensional objects. The placement and layout is based on similarity of various characteristics and cluster relationships according to the processing in 2). The individual media items of a media item group are revealed on a different layer (see 2) and 4)). Individual media items may be visualized alongside groups of media items. Descriptive labels and other forms of visual enrichment (e.g. album cover arts) may be attached to the visualization, or media item groups or media items. The visual representation is carried out on screens of devices such as, but not limited to, portable music players, mobile phones, smart phones, touch screen devices, tablet computers, portable computers, portable digital assistants, notebook computers, personal computers (including Web browsers), public screens, public terminals, Web terminals, video walls, interactive walls, etc. The visual representation may also be projected by projecting devices, on walls and other objects.

Optionally, the method according to the invention can further comprise one or both of the following steps:
4. Adaption of Visual representation—Interaction. The visual representation may be adapted and changed
   a) automatically
   b) through user input (interaction), e.g., but not limited to, pressing keys or buttons of a device, touching the screen of a device, performing gestures, physical manipulation of objects, sensoric input, implicit input (walking by) etc.
   User interaction changes and adapts the visual representation, particularly (but not limited to) the presentation of level of detail or different views or layers of the clustering and visualization process as described in 2) and 3).
5. Retrieval and Activation of Reproduction/Playback. Through similar interaction as outlined in 4b), or other, the according media item(s) may be selected, retrieved, visualized and/or played back (reproduced), or handled in a different way (e.g., but not limited to, moved to a shopping basket, etc.).

The method may be carried out on any type of computing device including, but not limited to, portable music players, mobile phones, smart phones, touch screen devices, tablet computers, portable computers, portable digital assistants, notebook computers, personal computers, server computers, public terminals, Web terminals, television sets, interactive installations, etc. The device performing the computing task may be identical to or different from the visualization device. The visual representation is carried out on screens of devices such as, but not limited to, portable music players, mobile phones, smart phones, touch screen devices, tablet computers, portable computers, portable digital assistants, notebook computers, personal computers (including Web browsers), public screens, public terminals, Web terminals, video walls, television sets, interactive walls, etc. The visual representation may also be projected by projecting devices, on walls and other objects.

In order to ease navigation in large media collections, the available items (i.e. the placement) are clustered and put into groups to create levels of less detail and create a better overview. These detail levels can be thought of as zoom levels comparable to Google Maps where the contents is more and more aggregated the further one zooms out. Visual objects such as circles, circular structures, rectangles, rectangular structures, shapes, polygons or three-dimensional objects can be used to visualize aggregated items. An object is represents a number of tracks and/or other objects, indicating the amount of tracks contained. The size might alternatively also depict other criteria such as usage frequency or other.

The invention further comprises an electronic device for organizing and visualizing electronic files comprising media items, comprising a user interface, a processing unit, and a storage unit, characterised in that media items are organized according to their similarity in content and/or meta information, and visualized as visual entities laid out and/or placed according to their similarity. As described above, the content can comprise an audio signal, an audio waveform, a video signal, video content, text content, image content, or combinations thereof.

The processing unit can comprise a feature extractor adapted to extract features from the content of the media items such as the rhythmic structure of the media item on one or more frequency bands to assess the similarity of media items. The meta information can comprise file-specific information such as file size, attached information such as ID3 tags, external information such as buying statistics, manually attached information such as tags or genre, artist, album, automatically attached information such as usage statistics.

The visual entities can comprise circles, circular structures, rectangular structures, colored shapes, polygons, three-dimensional objects, or combinations thereof. The electronic device can comprise a portable music player, mobile phone, smart phone, touch screen device, tablet computer, portable computer, portable digital assistant, notebook computer, personal computer, computer with a web browser, public screen, public terminal, video wall, projecting device, Hi-Fi devices, television set or interactive wall. The expression ‘electronic device’ comprises distinct single electronic devices as well as systems of two or more connected electronic devices performing functions according to the invention. It might be possible, for example, that the user interface and the storage unit are located in separate electronic devices.

The user interface can comprise means to select, retrieve, visualize, and/or play back the media items, and/or means to move the media items into a shopping basket. The electronic device can further comprise means to access external processing units and/or external databases. The visualization might be adaptable and/or changable through user input or automatically. Particularly, the visualization window can be implemented as a self-organizing map, where each item is assigned to one grid node. The size of the grid can be chosen in relation to the size of the media pool (number of media items). Other clustering methods can also be used. Labels can be placed independently of groups or media items. The processing unit and the user interface might be located in separate electronic devices.

Further aspects of the invention can be taken from the claims, the figures, and/or the drawings. A more complete understanding of the invention can be so obtained by the following description of the embodiments in connection with the attached drawings.

### BRIEF DESCRIPTION OF THE DRAWINGS

FIG. 1 shows a an exemplary embodiment of a media item according to the invention;

FIG. 2 shows an exemplary embodiment of a method to organize and visualize media items according to the invention;

FIG. 3a-3b show different embodiments of the steps of grouping and visualizing the media items;

FIG. 4a-4b show different embodiments of the visualization of meta information using global and local labels;

FIG. 5 shows three zoom levels in a visualization example according to the invention;

FIG. 6a-6b show different embodiments of the electronic device according to the invention;

FIGS. 7a-7d show different snapshots of an exemplary user interface according to the invention;

FIGS. 8a-8b show further different embodiments of the electronic device according to the invention.

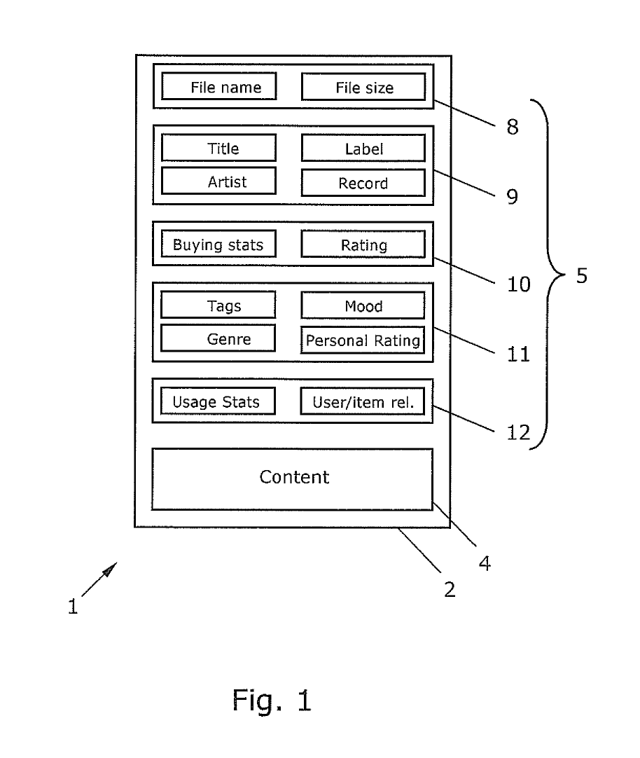

FIG. 1 shows an exemplary embodiment of a an electronic file 1 comprising a media item 2 according to the invention. The media item 2, which is for example an audio track, a video, an ebook, a digital picture or any other electronic media item, comprises content 4 and meta information 5. The content 4 might be a digital representation of an audio signal, an image, text or a video signal. The meta information 5 comprises file-specific information 8, attached information 9, external information 10, manually attached information 11, and automatically attached information 12.

The file-specific information 8 comprises the file name, the file size, and other file system information which is provided with the electronic file 1. The attached information 9 comprises information that is attached to the media item 2 such as the title, the artist, the label, and the record. There might be many more information that is attached to the media items 2, for example provided by ID3 tags. The external information 10 comprises information that is provided from external sources, such as local databases or internet databases. The information stored in these external databases might comprise buying statistics or a rating value. Further, the manually attached information 11 comprises tags for the media item 2, the genre or genres added by the user, the emotional mood associated with the media item 2, or the personal rating such as a number of stars or a score. Finally, the automatically attached information 12 comprises automatically generated information such as usage statistics or user/item relations in a multi-user environment.

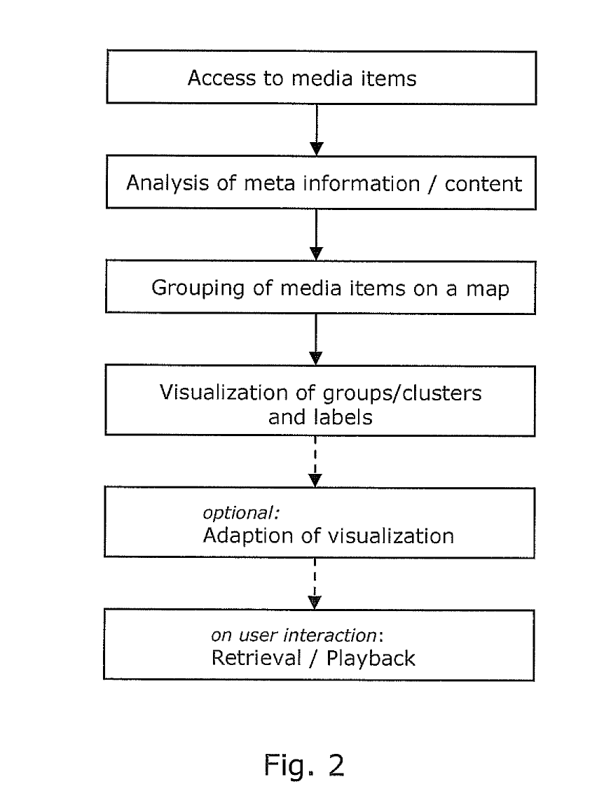

FIG. 2 shows the basic steps of the proposed method. In a first step, electronic files 1 comprising the media items 2 are accessed. The content 4 and the meta information 5 is extracted and analyzed. In this step, a feature vector can be created, which may comprise particular or all parts of the meta information 5. Further, the step may also comprise a spectral analysis of the content to extract particular spectral features.

The feature vector characterizes the media item with respect to any characteristic of the meta information 5 or the content 4. The multi-dimensional feature vectors are then grouped and organized according to their similarity. This can in practice be performed by building up a local or external database which comprises identifiers representing the media items and the corresponding multi-dimensional feature vectors. Further, the media items are visualized according to the similarity of their feature vectors. It is important to note that the similarity might be derived from the similarity in any specific part of the meta information (for example, only the genre), or by any combination of the available meta information and content. Groups or clusters of media items and/or individual media items are visualized by visual entities, such as circles, circular structures, rectangular structures, colored shapes, polygons, three-dimensional objects, and so on.

In an optional step of the method, the visualization is adapted automatically or by user input (interaction). This might comprise a changing of the level of detail in visualization or an adaption of the displayed information. In a further optional step of the method, respective media items can be selected, retrieved, visualized and/or played back (reproduced) or handled in a different way (for example, moved to a shopping basket).

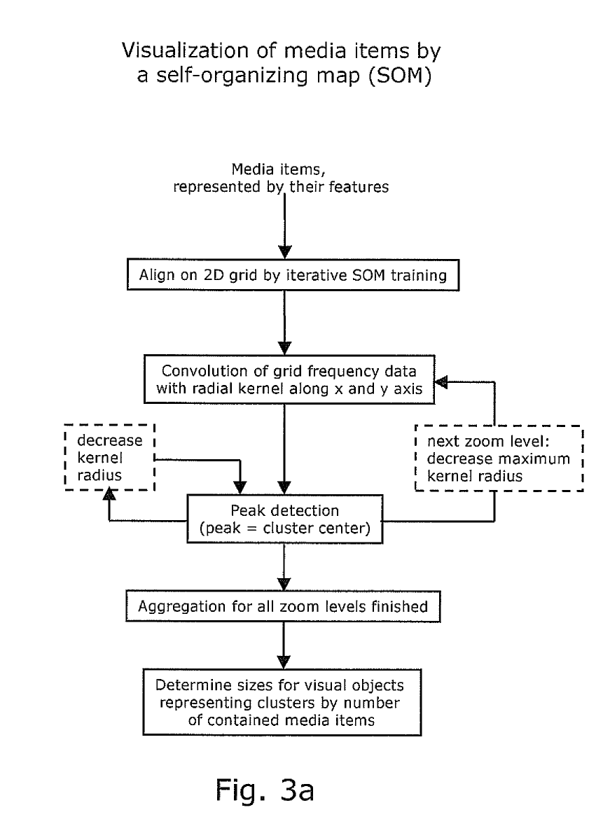

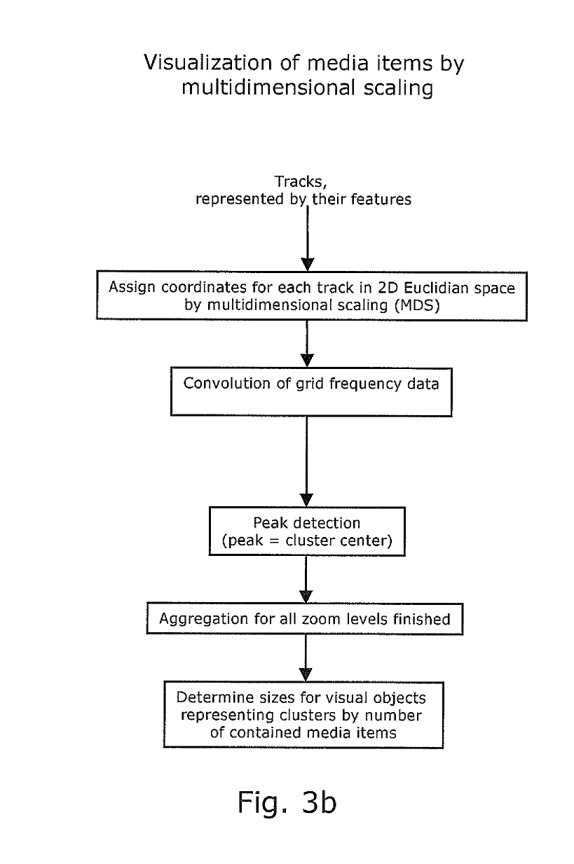

FIG. 3a shows a first exemplary embodiment of the visualization method to organize and visualize media items according to the invention. In a first step, the media items, which have been accessed and analyzed, are aligned on a two-dimensional grid by iterative SOM (self-organizing map) training based on their feature vectors. A count of media items per grid node is performed, resulting in a matrix of frequencies per grid node. The matrix is convoluted with a radial kernel along the x-axis and the y-axis with decreasing radius. The chosen maximum kernel radius is determined by the zoom level. Then, peaks are detected, which indicate the location of cluster centers.

Typically, there will be several zoom levels, and for every zoom level the steps are repeated with decreasing kernel size. If the processing is finished for all zoom levels, the resulting images are aggregated and the size of visual entities is determined by the number of media items contained. The location of visual entities is determined by the peak location.

FIG. 3b shows a second exemplary embodiment of a method to organize and visualize media items according to the invention. In a first step, the media items, which have been accessed and analyzed, are aligned on a two-dimensional grid by multi-dimensional scaling based on their feature vector. The resulting two-dimensional grid is then processed in a similar manner as shown in FIG. 3a (kernel convolution with decreasing kernel size, peak detection, aggregation and placement of visual entities) with possibly different kernel shapes.

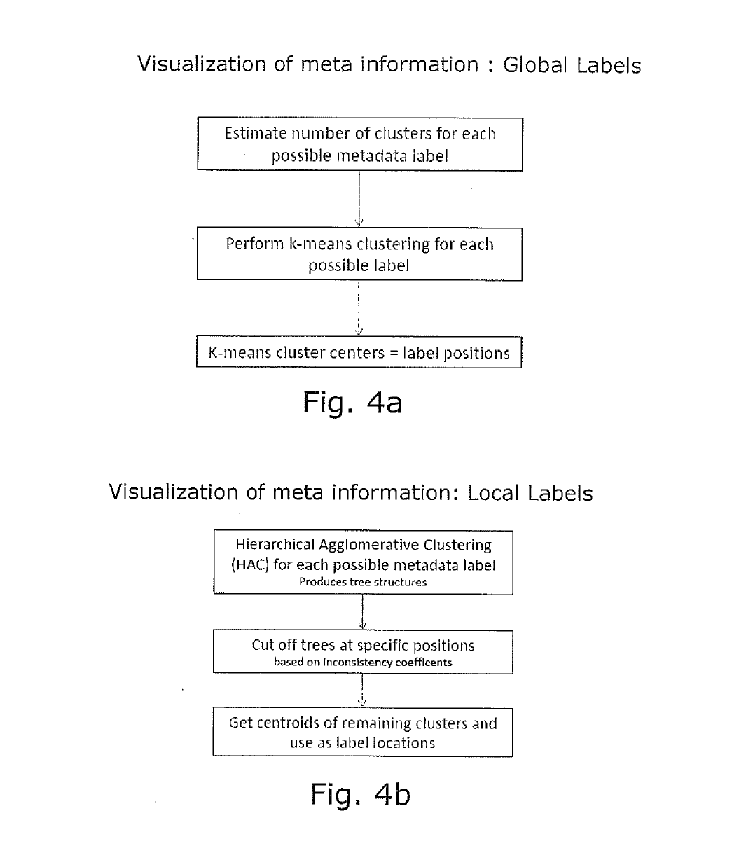

FIGS. 4a and 4b show an embodiment of a method for the visualization of global and local labels. For the global labels (FIG. 4a), the number of clusters for each possible metadata label is estimated first. Then, for each possible label, a k-means clustering is performed, and the label position is determined by the k-means cluster center. For the local labels (FIG. 4b), a tree structure is produced for each possible metadata label. The tree structure is cut off at specific positions based on chosen inconsistency coefficients. Then, the label locations are determined as the centroids of remaining clusters.

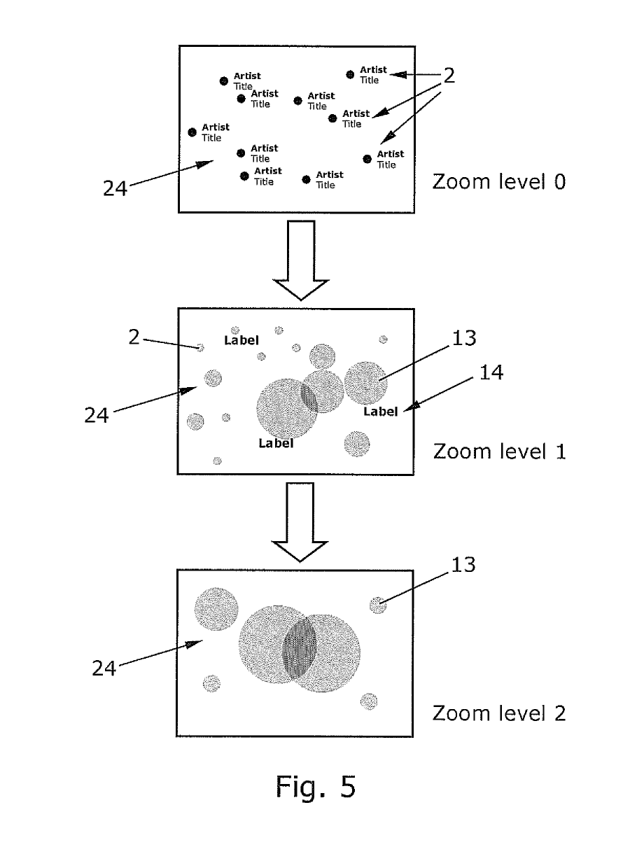

FIG. 5 shows three zoom levels in a visualization example according to the invention. In a first layer, a very high level of detail is achieved by showing every single media item 2 in the visualization window 24. In a second zoom level, individual media items 2 are grouped or clustered and form groups 13, which are provided with labels 14, for example denoting the artist, the genre, or the emotional mood of similar media items. These labels 14 can be local labels, based on cutting off a precomputed tree of labels at specific positions, or global labels based on a k-mean filtering.

Individual media items that do not belong to a group are still shown. In a third level, only groups 13 and/or clusters of similar groups are shown. It is important to note that groups 13 are allowed to overlap. Labels 14 and other forms of visual enrichment (e.g. album cover arts) may be attached to the visualization of groups 13 or media items 2. In this zoom level, only global levels may be shown.

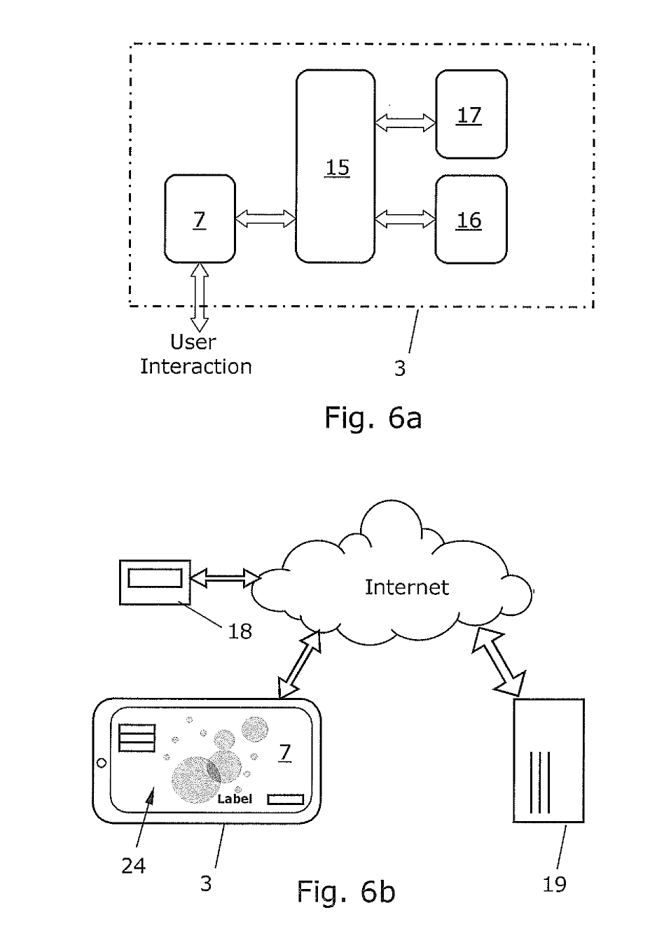

FIG. 6a shows an exemplary embodiment of an electronic device 3 according to the invention. The electronic device 3 comprises a user interface 7, a processing unit 15, a storage unit 16, and a feature extractor 17. It can be connected to the internet to download specific information regarding the processed media items. The user interface 7 allows interaction with the user.

FIG. 6b shows a further exemplary embodiment of the system according to the invention. In this case, the user interlace 7 is located in an electronic device 3, that is connected to the Internet. The media items 2 are stored on a server 19 connected to the internet. Instead of the internet, the connection might also be provided as a local area net (LAN), a wireless LAN (WLAN), a wide area net (WAN) or any other electronic network such as a 3G or 4G mobile network. Other data such as meta information 5 is stored on a database 18.

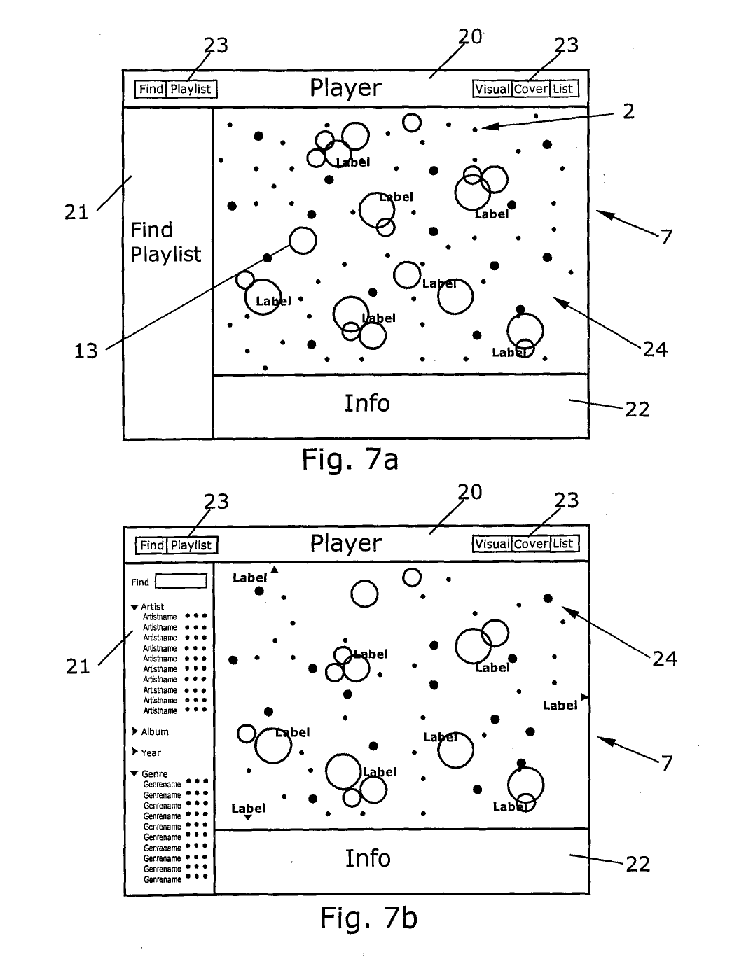

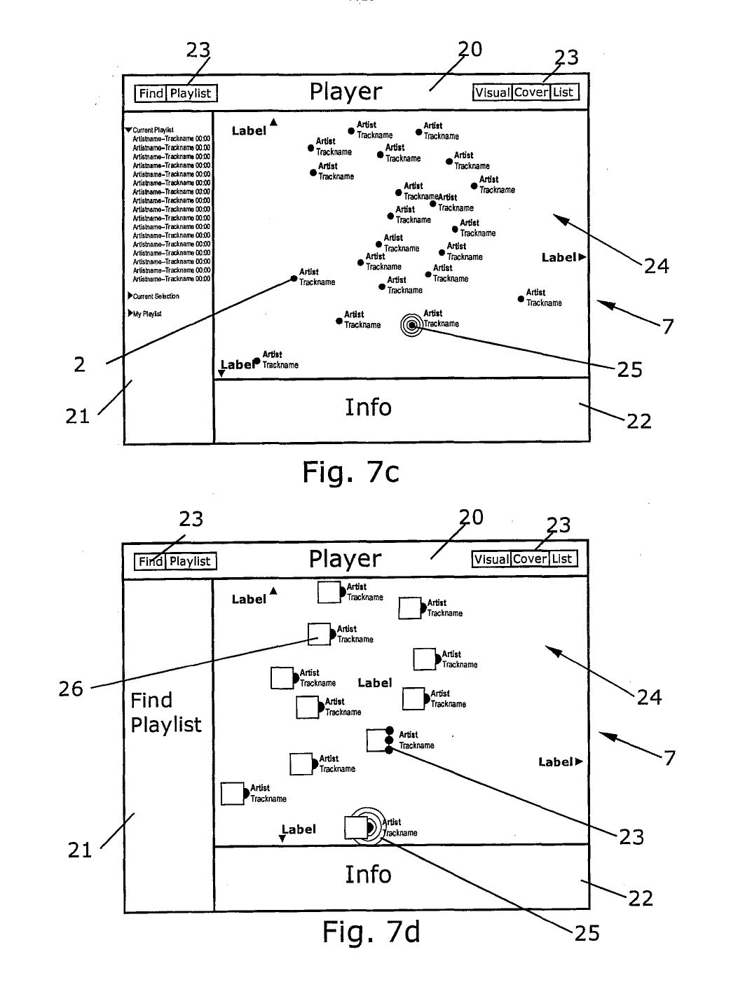

FIGS. 7a-7d show different snapshots of an exemplary user interface according to the invention. The user interface 7 is divided into a top panel 20 which comprises a player, a side panel 21 which comprises functionalities for searching, filtering, creation of playlists, and purchasing of media items, the visualization window 24, and a lower panel 22 with information about the status.

The player incorporates the following functionalities: play back, pause, next track, last track, volume control, display information about the track (such as artist, album, title, genre, etc.), and display of a time bar. Extended functionalities include an equalizer, shuffle, repeat, and advanced visualization features (spectrum, etc.). Artist information, other meta information or related media items including music videos can be displayed.

The search and filter functionalities comprise a search field, where users can input their search criterion. The resulting media items are highlighted in the visualization window. This also comprises a smart search functionality where potential search criterions are anticipated. For the filter functionality, only media items that match the filter criteria are shown in the visualization window. Further search features comprise a ‘new/recently’ option to show media items that have been added recently, a ‘popular’ option to highlight popular media items, and a ‘You may also like’ option to highligh media items that match certain user-specific criteria.

The visualization is structured into hierarchical levels, with the individual media items at the lowest level, and the groups or clusters at the highest level.

The user can zoom between these levels. The number of levels is not fixed but depends on the size and diversity of the media pool, i.e. the number and similarity of the media items.

To ease navigation, certain groups are superscribed with labels. A minimap might also be part of the visualization. The placement of tracks in the visualization window is done by an algorithm which takes the similarity between media items into account. The organization of media items (the placement) is stable, to ease orientation for the user. User find their preferred media items in general at the same place. However, the organization scheme might be adapted if users add or remove media items.

The different visualization levels can be accessed by interaction with buttons 23. The start screen shown in FIG. 7a shows in the visualization window 24 both individual media items 2 and groups 13. Further, clusters of adjoining groups 13 are visible. The user can directly interact with the media items 2, the groups 13 or the clusters (display meta information, play back the media items or group, add them to a play list, and so on). Labels 14 are used to denote certain groups (for example, by artist or genre) and therefore assist the user in navigating the media item pool. Users might also assign own labels to groups or clusters.

With the search and filter functionality, user can exclude or search for particular features of media items in the pool. If media items are suppressed from the visualization, the groups or clusters including these media items shrink respectively. It is also stipulated that users create their own customized start screens, which provide certain preferred media items, play lists or groups (“top 10”, “author's choice”, etc.). In a multi-user environment, registered users can change the settings of the visualization according to their preferences.

The change between zoom levels can be performed in a graphically animated fashion to indicate to give the user a feedback on the size of their media pool. Nearby labels which are located outside of the current visualization window are shown at the edges of the visualization window, as shown in FIG. 7c.

FIG. 7d shows a detailed zoom at the level of individual media items 2. This level is the lowest level, where the specific meta information 5 of a media item 2 is shown next to the visual entity representing the media item 2. The user can directly interact with the individual media items, for example tracks. The media item that is currently played back is highlighted in a specific fashion.

Possible interactions with the media item 2 include clicking on it (to show information), double-clicking (to play it back), drag and drop the media item to the player (top panel 20) or play list (side panel 21), or clicking the right mouse button (or an equivalent user interaction) to display context information. On a touch screen device, the respective user interaction features will be provided.

Additional information displayed might comprise information about the artist, song lyrics, links to videos, concerts, or comments of other users. These information might be provided by external databases, particularly from servers on the internet.

FIG. 7d shows a zoom level on which cover information 26 is shown. A cover is represented on a grid of at least 60 pixels×60 pixels. In this visualization scheme, certain functionalities are directly attached to the cover by buttons, such as playing back the media item or the album, or adding the media item or the album to the play list.

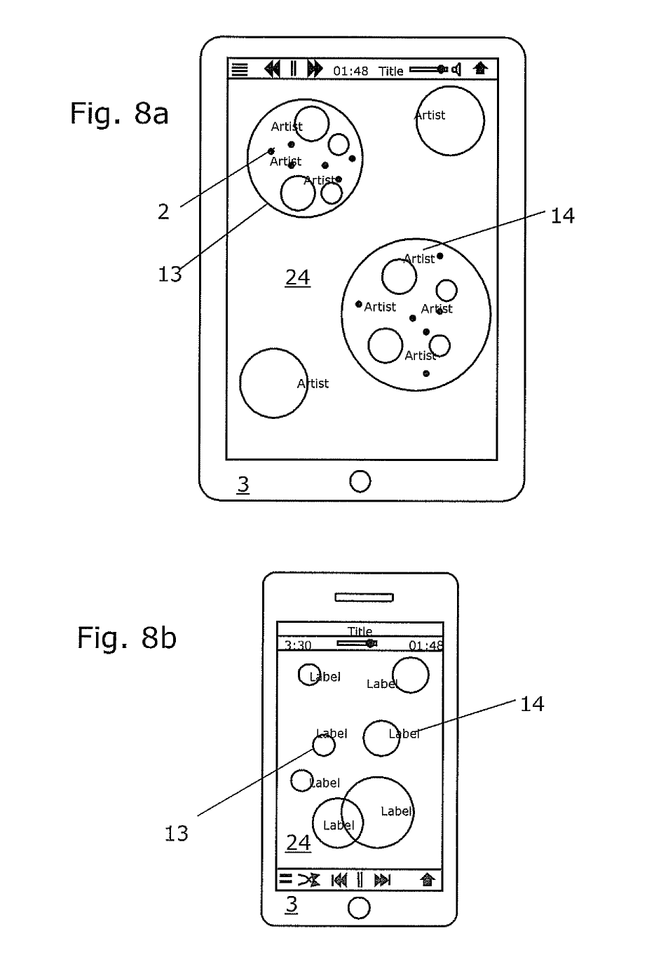

FIGS. 8a and 8b show further embodiments of the electronic device 3, either as a tablet computer as shown in FIG. 8a, or as a smartphone in FIG. 8b. The electronic devices have different user interfaces, but show a similar visualization window 24 with groups 13 and labels 14, while individual media items 2 are only shown on the tablet computer.

The invention is not limited to the described embodiments, but comprises as well further embodiments that fall within the scope of the claims. Individual features and characteristics of the invention shown in particular embodiments can be combined and are not limited to the particular embodiment. In particular, the invention is not limited to a specific visualization and design of the user interface, nor to a specific kind of media item. The invention is also not limited as to the characteristic which is used for the assessment of similarity.
1 Electronic file
2 Media item
3 Electronic device
4 Content
5 Meta information
6 Visual entity
7 User interface
8 File-specific information
9 Attached information
10 External information
11 Manually attached information
12 Automatically attached information
13 Group
14 Label
15 Processing Unit
16 Storage Unit
17 Feature Extractor
18 Database
19 Server
20 Top panel
21 Side panel
22 Lower panel
23 Buttons
24 Visualization window
25 Highlighted media item
26 Cover information

1-25. (canceled)

26. Method to organize and visualize electronic files (1) comprising media items (2) on an electronic device (3), the method comprising the following steps:
a) accessing and opening the electronic files (1) and analysis of the media items (2) to extract content (4) and/or meta information (5);
b) organization of media items (2) according to their similarity in content (4) and/or meta information (5);
c) visualization of media items (2) as visual entities (6) laid out and/or placed on a user interface (7) according to their similarity,
characterised in that the media items (2) are organized in hierarchical groups (13) and grouping/clustering is performed on various levels of detail.

27. Method according to claim 26, characterised in that the content (4) comprises an audio signal, an audio waveform, a video signal, video content, text content, image content, or combinations thereof.

28. Method according to claim 26, characterised in that the meta information (5) comprises
a. file-specific information (8) such as file size,
b. attached information (9) such as ID3 tags, artist, album,
c. external information (10) such as buying statistics,
d. manually attached information (11) such as tags, or genre,
e. automatically attached information (12) such as usage statistics.

29. Method according to claim 26, characterised in that spectral features such as the rhythmic, timbral and/or visual structure are extracted from the content (4) of the media items (2) on one or more frequency bands to further assess the similarity of media items (2).

30. Method according to claim 26, characterised in that the visualization comprises the steps of placement of the media items on a grid using a dimensionality reduction method such as iterative self-organizing map training or multidimensional scaling.

31. Method according to claim 30, characterised in that the visualization comprises the steps of processing the grid data with a kernel of arbitrary, preferably radial, shape decreasing in size and peak detection to generate and place the visual entities (6).

32. Method according to claim 26, characterised in that the precomputed visualizations of predetermined zoom levels are stored in a database.

33. Method according to claim 26, characterised in that the visual entities (6) comprise circles, circular structures, rectangular structures, polygons, colored shapes, three-dimensional objects, or combinations thereof.

34. Method according to claim 26, characterised in that meta information (5) is visualized by displaying descriptive labels (14).

35. Method according to claim 34, characterised in that the labels (14) are clustered and the clusters are labeled and the number and placement of the cluster labels is determined by the following steps:
a. Estimation of the number of clusters for each possible label;
b. K-means clustering for each possible label;
c. determination of label position by its cluster center.

36. Method according to claim 34, characterised in that the labels (14) are clustered and the clusters are labeled, and the number and placement of the cluster labels are determined by the following steps:
a. Hierarchical agglomerative clustering for each possible metadata label;
b. cut off of the hierarchical tree at specific positions;
c. determination of label positions by location of centroids of remaining clusters.

37. Method according to claim 26, characterised in that the visualization is adapted and/or changed through user input or automatically.

38. Method according to claim 26, characterised in that media items (2) are selected, retrieved, visualized, and/or played back, and/or moved into a shopping basket by user interaction.

39. Method according to claim 26, characterised in that the positions of media items or groups are stored in a Geographic Information Systems database.

40. Computer program, characterised in that the computer program implements a method according to claim 26.

41. Computer readable medium, characterised in that the computer readable medium comprises a computer program according to claim 40.

42. Electronic device (3) for organizing and visualizing electronic files (1) comprising media items (2), comprising a user interface (7), a processing unit (15), and a storage unit (16), characterised in that media items (2) are hierarchically organized according to their similarity in content (4) and/or meta information (5), where grouping/clustering is performed on various levels of detail, and visualized as visual entities (6) laid out and/or placed according to their similarity.

43. Electronic device (3) according to claim 42, characterised in that the content (4) comprises an audio signal, an audio waveform, a video signal, video content, text content, image content, or combinations thereof.

44. Electronic device (3) according to claim 42, characterised in that the processing unit (15) comprises a feature extractor (17) adapted to extract spectral features from the content (4) of the media items (2) such as the rhythmic, timbral and/or visual structure of the media item (2) on one or more frequency bands to further assess the similarity of media items (2).

45. Electronic device (3) according to claim 42, characterised in that the meta information (5) comprises
a. file-specific information (8) such as file size,
b. attached information (9) such as ID3 tags, artist, album,
c. external information (10) such as buying statistics,
d. manually attached information (11) such as tags or genre, artist, album,
e. automatically attached information (12) such as usage statistics.

46. Electronic device (3) according to claim 42, characterised in that the visual entities (6) comprise circles, circular structures, rectangular structures, colored shapes, polygons, three-dimensional objects, or combinations thereof.

47. Electronic device (3) according to claim 42, characterised in that the electronic device (3) comprises a portable music player, mobile phone, smart phone, touch screen device, tablet computer, portable computer, portable digital assistant, notebook computer, personal computer, computer with a web browser, public screen, public terminal, video wall, projecting device, Hi-Fi device, television set, or interactive wall.

48. Electronic device (3) according to claim 42, characterised in that the user interface (7) comprises means to select, retrieve, visualize, and/or play back the media items (2), and/or means to move the media items (2) into a shopping basket.

49. Electronic device (3) according to claim 42, characterised in that the electronic device comprises means to access external processing units (15) and/or external databases (18).
